(19) United States
(12) Patent Application Publication
(10) Pub. No.: US 2025/0343013 A1
(43) Pub. Date: Nov. 6, 2025

(54) TAP MODIFICATION DEVICE CONFIGURED TO PROVIDE ENHANCED OPERATING FREQUENCY RANGE

(71) Applicant: PPC BROADBAND, INC., East Syracuse, NY (US)

(72) Inventors: Paul BAILEY, Camillus, NY (US); David BARANY, Syracuse, NY (US)

(73) Assignee: PPC BROADBAND, INC., East Syracuse, NY (US)

(21) Appl. No.: 19/196,921

(22) Filed: May 2, 2025

Related U.S. Application Data
(60) Provisional application No. 63/642,084, filed on May 3, 2024.

(51) Int. Cl. H01H 9/00

(52) U.S. Cl. CPC H01H 9/0027; H01H 9/0016

(57) ABSTRACT

A tap modification device is configured to modify an in-use signal tap to provide an enhanced frequency operating range. The device includes an operating frequency enhancement portion structurally configured to provide an enhanced operating frequency range of a signal tap. The operating frequency enhancement portion is structurally configured to provide the enhanced operating frequency range that extends up to at least about 1800 MHZ. The operating frequency enhancement portion is structurally configured to couple with an in-use signal tap so as to modify the in-use signal tap to operate in the enhanced frequency range.

### CROSS REFERENCE TO RELATED APPLICATION

This application claims the benefit of U.S. Provisional Patent Application No. 63/642,084, filed on May 3, 2024, the disclosure of which is hereby incorporated by reference herein in its entirety

### TECHNICAL FIELD

The present invention relates generally to a tap modification device configured to provide enhanced frequency performance. In particular, the present invention relates to a tap modification device configured to modify or retrofit a tap to provide enhanced frequency performance.

### BACKGROUND

Broadband data and communications networks utilize line distribution taps to distribute signals over the networks by dividing an input signal received from a distribution line at an input port to two or more external subscriber ports and output the signals to the distribution line via an output port. Current taps may provide frequency ranges of up to 1000 MHz to about 1200 MHz.

To address demand for transport of increasing amounts of data over such networks, providers need to upgrade their networks to extend the operating frequency range to operate at broader frequency ranges. For example, ANSI/SCTE 264 2020 set standards for 2, 4 and 8-way line distribution taps including that the tap faceplate shall operate at frequencies at least 1794 MHz.

Accordingly, network providers need to upgrade taps to this higher frequency range. Such upgrades typically involve replacing the faceplate of the tap with a faceplate designed to operate at the higher frequency range. However, when the tap is in use providing service to customers and needs to be upgraded to operate at the higher frequencies, replacing the faceplate requires disconnecting the signal to the customers connected to the tap while the faceplate of the tap is being replaced.

Accordingly, it may be desirable to provide a device configured to upgrade the tap to operate at the higher frequencies. In some aspects, it may be desirable to upgrade the tap to operate at the higher frequencies while maintaining service to downstream customers via a distribution line from the tap.

### SUMMARY

In accordance with various embodiments of the present disclosure, a tap modification device is configured to modify an in-use signal tap to provide an enhanced frequency operating range. The device includes an operating frequency enhancement portion structurally configured to provide an enhanced operating frequency to a signal tap, a receiving portion structurally configured to receive a connection portion of the signal tap to electrically connect the operating frequency enhancement portion with a signal tap, and an access portion structurally configured to provide access to a continuity portion of the signal tap when the operating frequency enhancement portion is connected to the signal tap. The operating frequency enhancement portion is structurally configured to provide the enhanced operating frequency range that extends up to at least about 1800 MHZ to the signal tap. The access portion is structurally configured to allow disconnection of the continuity portion of the signal tap when the operating frequency enhancement portion is connected to the signal tap. The operating frequency enhancement portion is structurally configured to couple with an in-use signal tap so as to modify the in-use signal tap to operate in the enhanced frequency range.

In accordance with various embodiments of the present disclosure, a tap modification device is configured to modify an in-use signal tap to provide an enhanced frequency operating range. The device includes an operating frequency enhancement portion structurally configured to provide an enhanced operating frequency range of a signal tap and a receiving portion structurally configured to receive a connection portion of the signal tap to electrically connect the operating frequency enhancement portion with a signal tap. The operating frequency enhancement portion is structurally configured to provide the enhanced operating frequency range that extends up to at least about 1800 MHz. The operating frequency enhancement portion is structurally configured to couple with an in-use signal tap so as to modify the in-use signal tap to operate in the enhanced frequency range.

In accordance with various embodiments of the present disclosure, a tap modification device is configured to modify an in-use signal tap to provide an enhanced frequency operating range. The device includes an operating frequency enhancement portion structurally configured to provide an enhanced operating frequency range of a signal tap. The operating frequency enhancement portion is structurally configured to provide the enhanced operating frequency range that extends up to at least about 1800 MHz. The operating frequency enhancement portion is structurally configured to couple with an in-use signal tap so as to modify the in-use signal tap to operate in the enhanced frequency range.

Various aspects of the device, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a view of a signal tap in accordance with disclosed aspects.

FIG. 2 is a view of a removable portion of a signal tap in accordance with disclosed aspects.

FIG. 3 is a schematic view of a circuit configured to retrofit a signal tap to provide enhanced frequency performance to the signal tap in accordance with disclosed aspects.

FIG. 4 is a front view of a tap retrofit element on a printed circuit board in accordance with disclosed aspects.

FIG. 5 is a back view of a tap retrofit element on a printed circuit board in accordance with disclosed aspects.

FIG. 6 is a view of a tap retrofit element and a continuity bar of a tap in accordance with disclosed aspects.

### DETAILED DESCRIPTION OF EMBODIMENTS

Embodiments of the disclosure provide a tap modification device configured to provide an enhanced frequency operating range to a signal tap.

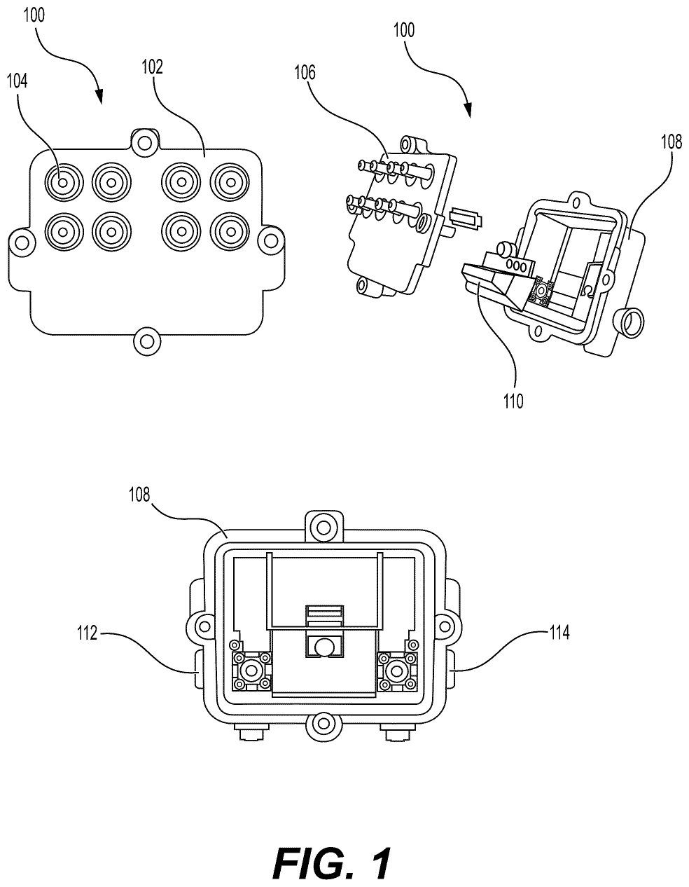

Referring first to FIG. 1, a signal tap 100 is depicted. The signal tap 100 may be configured to distribute signals to a plurality of external subscriber ports 104. In some embodiments, the signal tap may be configured to provide the signals operating in a frequency range of up to about 1200 MHZ. The signal tap 100 may include an input port 112 configured to connect to and receive signals and power from a distribution line and an output port 114 configured to connect to and output signals and power along the distribution line. In some embodiments, the signals may be RF CATV signals and the power may be high voltage (typically 60 or 90 VAC, 60 Hz, 15-20 Amps), although other types of signals and power levels may be used.

In some embodiments, the signal tap 100 may have an external housing 102. The housing 102 may include a cover portion 106, a lower portion 108, and a removeable portion 110. The removable portion 110 may include electrical components configured to result in operation of the signals at frequencies of up to about 1200 MH. However, in use signal taps may need to be upgraded to operate at higher frequencies such as 1800 MHZ, 3000 MHz or higher, often when the signal taps are in use distributing signals in the field. This upgrade to higher operating frequencies would conventionally include removing the cover portion 106 of a signal tap and removing or disconnecting the electrical components, which would then be replaced with electrical components that provide the capability of operating at the higher frequencies. During such an upgrade, the signals along the signal distribution line would be interrupted, which could result in many subscribers connected to the distribution line being disconnected from receiving signals over the distribution line with a loss in service until the upgrade is completed. Often, the entire cover portion 106 would be replaced.

Embodiments disclosed herein are configured to modify or retrofit in-use signal taps 100 to operate at the higher frequencies of 1800 MHZ, 3,000 MHz or up to 4000 MHz or higher, as further described herein. Some embodiments may be configured to modify or retrofit in-use signal taps 100 to operate at the higher frequencies of 1800 MHz, 3,000 MHz or up to 4000 MHz or higher while maintaining continuity of service of signals provided by the signal tap to a distribution line.

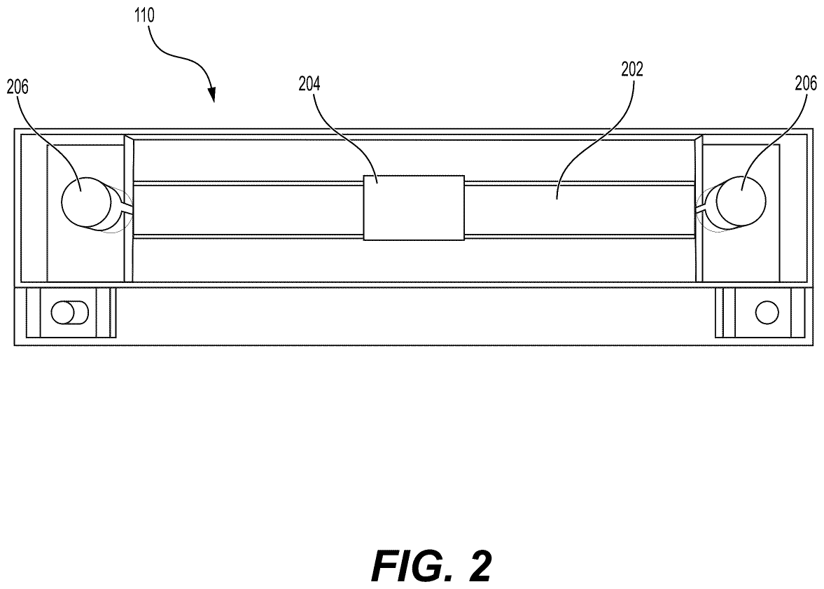

FIG. 2 illustrates a removable portion 110 of a signal tap such as the signal tap 100 illustrated in FIG. 1. The removable portion 110 may or may not include electrical circuitry, which could be formed on a top or bottom side of the removable portion 110. The removable portion 110 includes a continuity bar 202 with an actuator 204 configured to connect the left and right portions of the continuity bar 202. The removable portion 110 may also include posts 206 configured to electrically connect the continuity bar 202 to the other circuitry of the tap 100. In some embodiments, the posts 206 may not be formed on the removable portion 110 coupled with the continuity bar 202 and the actuator 204, but may instead be a separate part mounted within the lower portion 108 of the tap 100.

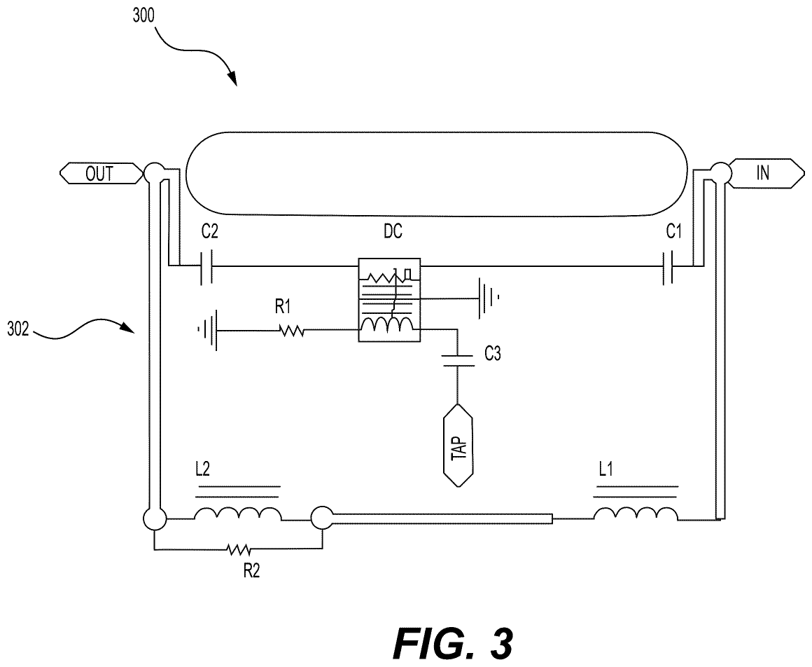

FIG. 3 illustrates a schematic 300 of a circuit with the electrical components to modify a signal tap 100 in accordance with various embodiments. The schematic illustrates the circuit 302 with various electrical components, including capacitors, inductors, resistors and a transformer. The schematic illustrates one example of circuitry that could be used to provide an enhanced frequency operating range to a tap of up to 1800 MHz, 3000 MHz or higher. Other circuits could be used with embodiments of the invention that provide the enhanced frequency operating range.

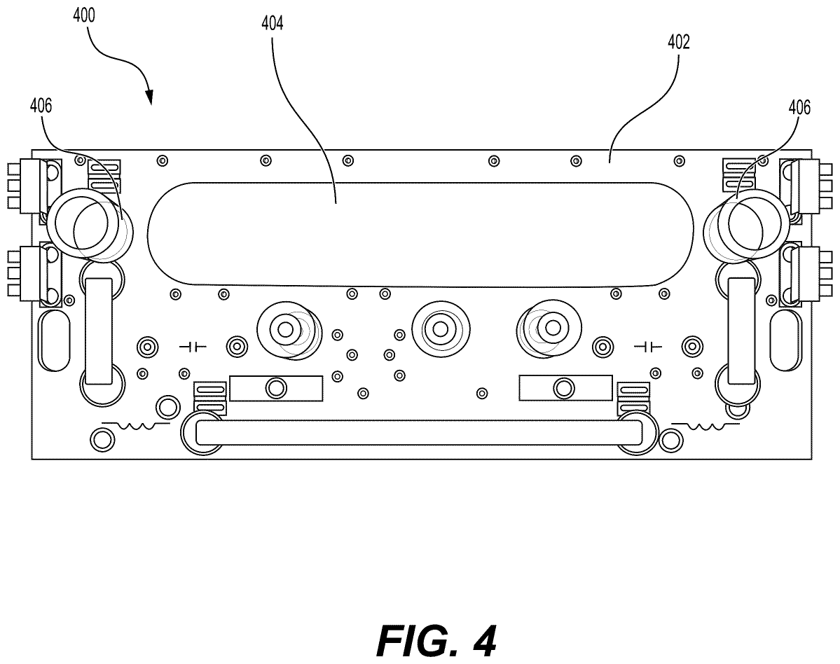

FIG. 4 illustrates a front view of tap modification device 400 (also known as a tap bridge) according to various embodiments. The tap modification device 400 may be configured to modify or retrofit an in-use signal tap to operate at an enhanced frequency range. Some embodiments may be configured to modify or retrofit an in-use signal tap to operate at an enhanced frequency range while maintaining continuity of service of signals provided to a distribution line while the signal tap is being modified or retrofitted. In various embodiments, the tap modification device 400 may include a printed circuit board 402. Some embodiments of the tap modification device 400 could be produced without a printed circuit board.

In various embodiments, the tap modification device 400 may include an access portion 404 and circuitry mounted on the printed circuit board 402. The circuitry may be configured as an operating frequency enhancement portion configured to enhance an operating frequency of a signal tap on which the tap modification device 400 is mounted to the tap to an enhanced operating frequency range, such as up to 1800 MHz or up to 3000 MHz or higher, when the tap was originally configured to operate at a lower frequency range, such as up to 1000 MHz or 1200 MHz. The tap modification device 400 may also include receiving portions 406 configured to connect the tap modification device 400 to a tap during retrofit, as further described herein.

The tap modification device 400 is configured to connect to the signal tap 100 to modify or retrofit the tap 100 to provide the enhanced frequency operating range. In some embodiments, the enhancement of the frequency range may be provided while maintaining continuity of service during the retrofit. To perform the modification, the cover 106 of the tap 100 removed. Then, the tap modification device 400 is inserted onto a connection portion of the tap 100, such as the posts 206, while the removeable element 110 is not removed from the tap 100. The receiving portions 406 of the tap modification device 400 may be configured to electrically connect to the posts 206. The receiving portions 406 may be configured with an opening in cylindrical elements, where the openings are configured to receive the posts 206 of the tap. Electrical contact with the posts 206 may be made by the receiving portions 406 or by a contact on the circuit board 402. The circuitry of the printed circuit board 402 is then connected to the tap 100 via the posts 206 and the receiving portions 406 to provide the enhanced frequency operating range to the tap 100.

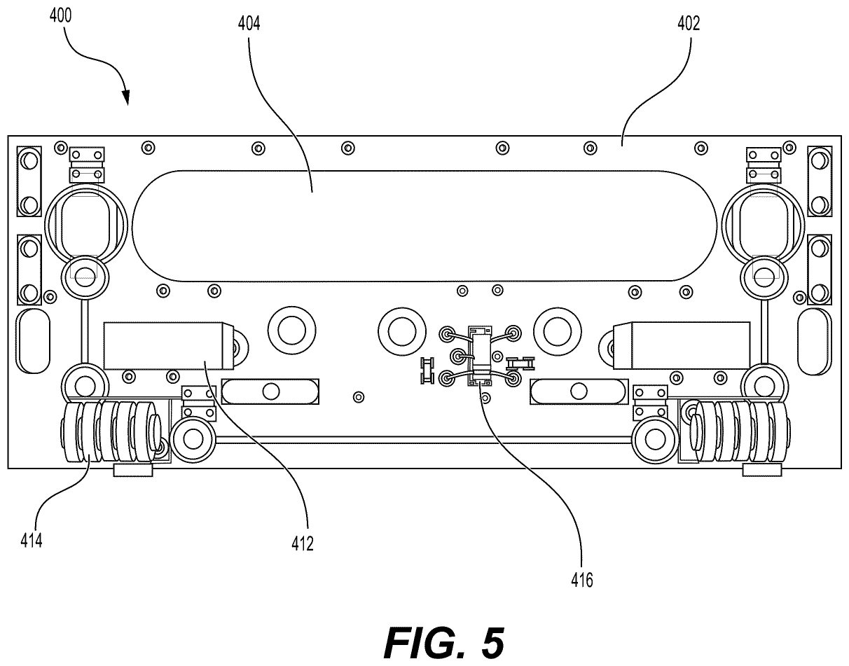

FIG. 5 illustrates a back or bottom view of the tap modification device 400. The circuit board 402 may be a double-sided circuit board as illustrated. In various embodiments, circuit elements may be mounted on either side or both sides of the circuit board 402. In this example, the circuit board may include one or more capacitors 412, one or more inductors 414 and one or more transformers 416, although any type of circuit elements may be included as needed. The circuit elements may be connected in a circuit on the circuit board 402 by traces and through holes to form the circuit. In various embodiments, the circuit is configured to retrofit the tap to provide an enhanced frequency operating range, which may be up to 1800 MHZ or up to 3000 MHz.

In some embodiments, the circuitry of the tap modification element 400 may provide additional functionality such as signal conditioning circuity or other functionality as needed.

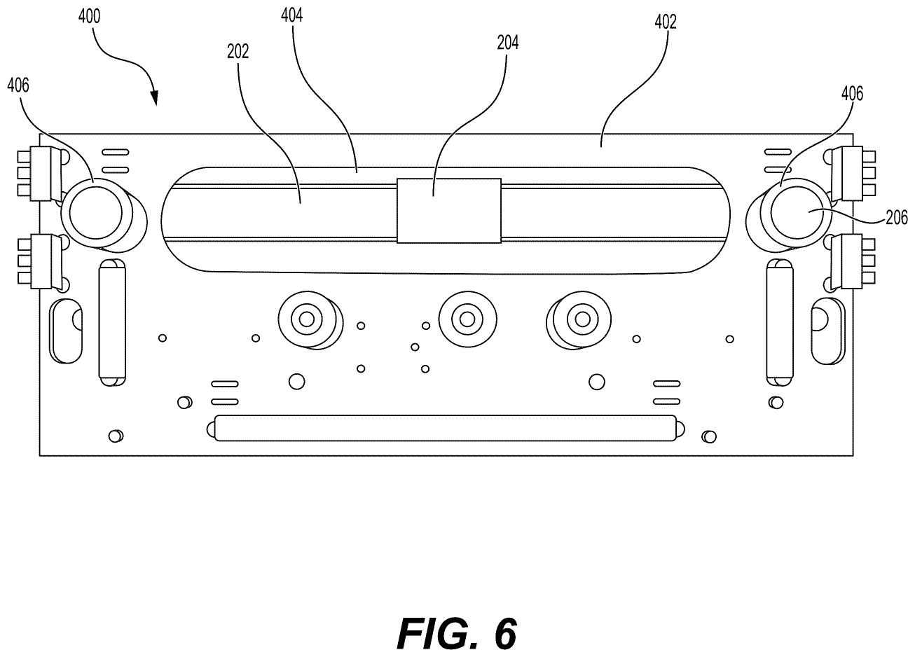

As illustrated in FIG. 6, the tap modification device 400 is configured to be inserted into the tap 100 to provide the enhanced frequency operating range. After the cover 106 is removed from the tap 100, the receiving portions 406 of the tap modification device 400 are configured to slide onto the posts (connection portion) 206 of the tap 100 such that the posts 206 (or another connection portion on the circuit board 402) make electrical contact with the circuit of the retrofit element 400.

The access portion 404 of the tap modification device 400 may be configured as an opening to leave the continuity bar 202 of the tap 100 exposed after the tap modification device 400 is installed. The tap modification device 400 is configured to connect the circuitry of the tap modification device 400 to the tap 100 to create a parallel circuit with the circuit of the continuity bar 202 and circuitry of the tap 100 connected to the continuity bar 202. Then, the continuity bar 202 can be removed or cut by access through the access portion 404 to disconnect the circuitry of the tap 100 that was configured to operate at up to 1000 or 1200 MHZ, leaving the circuitry of the tap modification device 400 connected to the tap. The tap 100 may thus be retrofitted with the circuitry of the tap modification device 400 to provide the enhanced frequency operating range of up to 1800 MHZ, or up to 3000 MHz or higher. The access portion 404 functions as a removal enabling element enabling removal of the continuity bar and disconnection of the circuitry of the tap configured to operate at 1000 or 1200 MHZ or less, and in some embodiments may be done without disconnecting the tap from the distribution lines so as to maintain service during the retrofit or modification of the tap.

This non-break in service during maintenance or retrofit of the taps 100 may be important to quality of service for all residences and businesses connected to the distribution line on the network. Additional features that may be provided by the modification device may include 1) over voltage and lightning protection that protects the circuits while meeting IEC and UL isolation requirements in high voltage applications, 2) non-interruptible RF & HV (Permanent continuity as opposed to actuator bypass CB), 3) improved, extended BW up to 3 GHz RF with isolated and dedicated RF Signal Path (separate from the HV path), 4) integrated splitter or directional coupler, simplifying and cost reducing tap cover plates (reducing configs to basic 2-4-8 way passive splitters), and 5) plug-in line conditioning modules such as attenuators, or equalizers.

Although the illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A tap modification device configured to modify an in-use signal tap to provide an enhanced frequency operating range to the in-use signal tap, comprising:
an operating frequency enhancement portion structurally configured to provide an enhanced operating frequency to a signal tap;
a receiving portion structurally configured to receive a connection portion of the signal tap to electrically connect the operating frequency enhancement portion with a signal tap;
an access portion structurally configured to provide access to a continuity portion of the signal tap when the operating frequency enhancement portion is connected to the signal tap;
wherein the operating frequency enhancement portion is structurally configured to provide the enhanced operating frequency range that extends up to at least about 1800 MHZ to the signal tap;
wherein the access portion is structurally configured to allow disconnection of the continuity portion of the signal tap when the operating frequency enhancement portion is connected to the signal tap; and
wherein the operating frequency enhancement portion is structurally configured to couple with an in-use signal tap so as to modify the in-use signal tap to operate in the enhanced frequency range.

2. The tap modification device of claim 1, wherein the access portion comprises an opening configured to expose the continuity bar of the signal tap to allow disconnection of the continuity bar.

3. The tap modification device of claim 1, wherein the receiving portion comprises a hollow post configured to receive and make electrical contact with the connection portion of the signal tap.

4. The tap modification device of claim 1, wherein the operating frequency enhancement portion comprises an electrical circuit configured to provide the enhanced operating frequency range to the signal tap.

5. The tap modification device of claim 1, wherein the operating frequency enhancement portion is configured to enhance the operating frequency of the in-use signal tap while maintaining continuity of signals output from the in-use signal tap to a distribution line.

6. A tap modification device configured to modify an in-use signal tap to provide an enhanced frequency operating range to the in-use signal tap comprising:
an operating frequency enhancement portion structurally configured to provide an enhanced operating frequency range of a signal tap;
a receiving portion structurally configured to receive a connection portion of the signal tap to electrically connect the operating frequency enhancement portion with a signal tap;
wherein the operating frequency enhancement portion is structurally configured to provide the enhanced operating frequency range that extends up to at least about 1800 MHZ; and
wherein the operating frequency enhancement portion is structurally configured to couple with an in-use signal tap so as to modify the in-use signal tap to operate in the enhanced frequency range.

7. The tap modification device of claim 6, further comprising an access portion structurally configured to provide access to a continuity bar of the signal tap when the operating frequency enhancement portion is connected to the signal tap using the receiving portion.

8. The tap modification device of claim 7, wherein the access portion is configured to allow disconnection of the continuity bar of the signal tap when the operating frequency enhancement portion is connected to the signal tap.

9. The tap modification device of claim 7, wherein the access portion comprises an opening configured to expose the continuity bar of the signal tap to allow disconnection of the continuity bar.

10. The tap modification device of claim 6, wherein the receiving portion comprises a hollow post configured to receive and make electrical contact with the connection portion of the signal tap.

11. The tap modification device of claim 6, wherein the operating frequency enhancement portion comprises an electrical circuit configured to provide the enhanced operating frequency range to the signal tap.

12. The tap modification device of claim 6, wherein the operating frequency enhancement portion is configured to enhance the operating frequency of the in-use signal tap while maintaining continuity of service of signals output from the in-use signal tap to a distribution line.

13. A tap modification device configured to modify an in-use signal tap to provide an enhanced frequency operating range of the in-use signal tap comprising:
an operating frequency enhancement portion structurally configured to provide an enhanced operating frequency range of a signal tap;
wherein the operating frequency enhancement portion is structurally configured to provide the enhanced operating frequency range that extends up to at least about 1800 MHZ; and
wherein the operating frequency enhancement portion is structurally configured to couple with an in-use signal tap so as to modify the in-use signal tap to operate in the enhanced frequency range.

14. The tap modification device of claim 13, further comprising an access portion structurally configured to provide access to a continuity bar of the signal tap when the operating frequency enhancement portion is connected to the signal tap using the receiving portion.

15. The tap modification device of claim 14, wherein the access portion is configured to allow disconnection of the continuity bar of the signal tap when the operating frequency enhancement portion is connected to the signal tap.

16. The tap modification device of claim 13, further comprising a receiving portion structurally configured to receive a connection portion of the signal tap to electrically connect the operating frequency enhancement portion to the signal tap.

17. The tap modification device of claim 14, wherein the access portion comprises an opening configured to expose the continuity bar of the signal tap to allow disconnection of the continuity bar.

18. The tap modification device of claim 16, wherein the receiving portion comprises a hollow post configured to receive and make electrical contact with the connection portion of the signal tap.

19. The tap modification device of claim 13, wherein the operating frequency enhancement portion comprises an electrical circuit configured to provide the enhanced operating frequency range to the signal tap.

20. The tap modification device of claim 13, wherein the operating frequency enhancement portion is structurally configured to enhance the operating frequency of the in-use signal tap while maintaining continuity of service of signals output from the in-use signal tap to a distribution line.
